(19) United States
(12) Patent Application Publication
(10) Pub. No.: US 2022/0272910 A1
(43) Pub. Date: Sep. 1, 2022

(54) SYSTEM AND METHOD FOR CONTROL OF SILVICULTURAL EQUIPMENT

(71) Applicant: Tigercat Industries Inc., Brantford (CA)

(72) Inventors: Jason OLYNIK, Brantford (CA); David SIMATOVIC, Brantford (CA)

(21) Appl. No.: 17/703,442

(22) Filed: Mar. 24, 2022

Related U.S. Application Data
(63) Continuation of application No. PCT/CA2020/051276, filed on Sep. 23, 2020.
(60) Provisional application No. 62/905,845, filed on Sep. 25, 2019.

(51) Int. Cl. A01G 23/00; E02F 3/20; E02F 3/18; E02F 9/26

(52) U.S. Cl. CPC A01G 23/00; E02F 3/20; E02F 3/188; E02F 9/265

(57) ABSTRACT

A method for controlling an attachment provided to a boom of a vehicle, the method including: sensing a ground force on the attachment; determining if the ground force is outside a target deadband, wherein the target deadband is based on a height of the attachment over the ground, and, if the ground force is outside the target deadband, adjusting a cylinder pressure to bring the ground force within the deadband. A system for controlling an attachment on a boom, the system including: a control system; a hydraulic system for at least a first piston provided to the boom; and a first pressure sensor for sensing a pressure related to the attachment and communicating the sensed pressure to the control system, wherein the control system determines if the pressure is outside a target deadband, and, if so, adjusts a pressure at the piston to bring the sensed pressure within the deadband.

### RELATED APPLICATIONS

This application is a continuation of PCT Application No. PCT/CA2020/051276 filed Sep. 23, 2020, which claims priority to U.S. Provisional Patent Application No. 62/905,845 filed Sep. 25, 2019, which is hereby incorporated herein by reference.

### FIELD

The present disclosure generally relates to a system and method for control of silvicultural equipment. In particular, the present disclosure relates to an active float system and method to allow a piece of silvicultural equipment attached to a vehicle to be supported to follow the contours of the ground during operation.

### BACKGROUND

Silvicultural equipment is used in a variety of applications from clearing land for planting through to the actual planting itself. In order to operate efficiently in forestry locations, the silvicultural equipment can be quite large. One example of silvicultural equipment that is used in forestry applications is a mulching device, sometimes called a mulching head. A mulching head is an example of an attachment, which can be carried by a wheeled or tracked vehicle and used to accomplish a silvicultural objective. As an example, a conventional mulching head is typically held with a geometry that is close to the ground and close to the vehicle carrying the mulching head. A conventional mulching head or other type of attachment may be supported by the vehicle with a fixed amount of force, for example a mulching head weighing 8000 pounds may be supported with a force of 5000 pounds to hold a portion of the weight of the mulching head off the ground. The fixed amount of force may provide acceptable performance for a mulching head held in a conventional geometry, however the fixed amount of force may not provide acceptable performance for mulching heads held in alternative geometries. Further, a fixed amount of force may not adequately allow for movement of the mulching head as the mulching head is moved along the ground by the vehicle

As such, there exists a need for an improved system and method for control/support of silvicultural equipment and, in particular, control/support of a mulching head that is attached to a vehicle.

### SUMMARY

According to an aspect herein, there is provided a method for controlling an attachment provided to a boom of a vehicle, the method including: sensing a ground force on the attachment; determining if the ground force is outside a first target deadband, wherein the first target deadband is configured based on a desired height of the attachment in relation to the ground, and, if the ground force is outside the first target deadband, adjusting a lift cylinder pressure to return the ground force to within the first target deadband, otherwise do not adjust the lift cylinder pressure.

In some cases, the adjusting the lift cylinder pressure may include varying the lift cylinder pressure over a predetermined response time or at a predetermined rate. In some cases, the vehicle may be operable at a creep speed and a drive speed and the response time may include a first response time corresponding to the creep speed and a second response time corresponding to the drive speed. In some cases the second response time may be shorter than the first response time.

In some cases, the adjusting the lift cylinder pressure to return the ground force to within the first target deadband may include varying the lift cylinder pressure to maintain a predetermined level of contact between the attachment and the ground.

In some cases, sensing a ground force may include sensing a base-end pressure of the lift cylinder. In this case, the sensing the ground force may include comparing the lift cylinder base-end pressure to a lift cylinder base-end free air reading.

In some cases, sensing a ground force may include sensing a base-end pressure of a tilt cylinder. In this case, the sensing the ground force may include comparing the tilt cylinder base-end pressure to a tilt cylinder base-end free air reading.

In some cases, the method may further include; sensing an attachment pressure related to operation of the attachment; determining if the attachment pressure is higher than a second target deadband; and if so, adjusting the lift cylinder pressure to return the attachment pressure to within the second target deadband.

In some cases, the attachment may be a mulcher for use with, for example, forestry equipment.

According to another aspect herein, there is provided a system for controlling an attachment provided to a boom of a vehicle, the system including: a control system; a hydraulic system in fluid communication with at least a first piston provided to the boom; and a first pressure sensor configured to sense a pressure related to the attachment, the first pressure sensor also configured to communicate the sensed pressure to the control system, wherein the control system is configured to determine if the pressure is outside a first target deadband, and, if so, adjust a pressure at the piston to return the sensed pressure to within the first target deadband, otherwise do not adjust the pressure at the piston.

In some cases, the first piston may be a lift cylinder for lifting the boom and the first pressure sensor senses a pressure at a base end of the lift cylinder. In this case, the first pressure sensor may alternatively sense the pressure by comparing the lift cylinder base-end pressure to a lift cylinder base-end free air reading.

In some cases, the first piston may be a tilt cylinder configured to adjust an angle of the attachment and the first pressure sensor senses a pressure at a base end of the tilt cylinder. In this case, the first pressure sensor may alternatively sense the pressure by comparing the tilt cylinder base-end pressure to a tilt cylinder base-end free air reading.

In some cases, the adjusting a pressure at the piston may include varying the pressure at the piston over a predetermined response time or at a predetermined rate. In some cases, the vehicle may be operable at a creep speed and a drive speed, the drive speed may be faster than the creep speed, and the response time may include a first response time corresponding to the creep speed and a second response time corresponding to the drive speed. In this case, the second response time may be shorter than the first response time.

In some cases, the system may further include: an attachment hydraulic system in fluid communication with the attachment; and an attachment pressure sensor configured to sense an attachment pressure related to operation of the attachment and communicate the attachment pressure to the control system; wherein the control system is further configured to determine that the attachment pressure is higher than a second target deadband, and in response to determining that the attachment pressure is higher than a second target deadband: increase the pressure at the piston to return the attachment pressure to within the second target deadband.

In some cases, the attachment may be a mulcher for use with, for example, forestry equipment.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 shows a schematic diagram of an embodiment of a system for controlling/supporting an attachment/mulcher head/silvicultural equipment;

FIG. 2 shows a flow diagram of an embodiment of a method of controlling/supporting an attachment/mulcher head/silvicultural equipment;

FIG. 3 shows a schematic diagram of an embodiment of a hydraulic system for controlling/supporting an attachment on a vehicle;

FIG. 4 shows a side view of an embodiment of a system for controlling/supporting an attachment/mulcher head/silvicultural equipment;

FIG. 5 shows a front view of the system of FIG. 4;

FIG. 6 shows a perspective view of the system of FIG. 4;

FIG. 7 shows a top view of the system of FIG. 4;

FIG. 8 shows another view of the system of FIG. 4, illustrating forces;

FIG. 9 shows a flow diagram for an embodiment of a method for controlling/supporting an attachment/mulcher head/silvicultural equipment;

FIG. 10 shows a flow diagram for an embodiment of a method for controlling/supporting an attachment/mulcher head/silvicultural equipment;

FIG. 11 shows a schematic of an embodiment of a sensor system for a system of the type shown in FIG. 4;

FIG. 12 shows a schematic of an embodiment of a control system for a system of the type shown in FIG. 4; and

FIG. 13 shows a flow diagram of an embodiment of a method of retrofitting or setting up the systems shown in FIGS. 11 and 12.

### DETAILED DESCRIPTION

The present disclosure describes embodiments of an improved system and method for control of silvicultural equipment and, in particular, for controlling and supporting an attachment such as a mulching head as the attachment moves over ground contours. Embodiments of the present disclosure are intended to be suitable for use with attachments mounted on vehicles of various types and, in particular, with mulching heads mounted on forestry equipment.

A mulching head may be mounted on a vehicle for forestry operations, for example mulching brush, stumps and other material present on the ground. Vehicles are typically supported by wheels or tracks. As the vehicle travels over the ground during a mulching operation, a change in elevation of the ground will cause a change in elevation of the vehicle once the wheels or tracks encounter the change in elevation. Conventional mulching heads are typically mounted close to the vehicle and close to the ground, as this minimizes the difference between the position of the conventional mulching head and the position of the (typically, front) wheels or tracks of the vehicle. As a result, there is minimal deviation between the elevation of the conventional mulching head and the elevation of the vehicle. This enables the conventional mulching head to remain close to or in contact with the ground with a relatively steady support force being applied to the mulching head, for changes in elevation.

However, if a conventional mulching head encounters a sudden rise in elevation, the conventional mulching head may be driven into the ground before the wheels or tracks of the vehicle are able to provide the necessary elevational change, potentially damaging both the mulching head and the ground being processed. Similarly, if a mulching head encounters a sudden drop in elevation, this may cause the mulching head to be entirely off the ground. In this event, the mulching head will typically be lowered at a slow rate, for safety reasons among others, to re-establish contact between the mulching head and the ground (sometimes referred to as a passive float event). Typically, a passive float event is only detected when the mulching head leaves the ground entirely, therefore passive float control methods do not actively maintain contact between the ground and the mulching head but only passively re-establish ground contact after it is lost.

Changes in elevation causing the mulching head to either be raised off the ground or driven into the ground are exacerbated for mulching heads mounted on a vehicle in a different geometry where the mulching head is not as close to the vehicle wheels, such as an elevated geometry. An elevated geometry may include mounting the mulching head to the vehicle via an extended boom. An elevated geometry may include a boom lift cylinder to raise or lower the attachment and a head tilt cylinder to change the angle of the attachment. An elevated geometry may include mounting the mulching head to the vehicle to allow the mulching head to be raised above the ground, for example to allow the mulching head to mulch a tree and/or a tree trunk at an elevation above the ground. A boom having sufficient length to allow the mulching head to be raised above the ground will typically require the mulching head to be positioned further forward from the vehicle when the mulching head is on the ground. An elevated geometry for the mulching head can amplify the difference in elevation between the mulching head and the vehicle while the vehicle is travelling, and may increase the frequency with which the mulching head is either lifted off the ground or driven into the ground due to changes in terrain elevation.

The present disclosure generally provides embodiments of a system and method for controlling or supporting an attachment, such as a mulching head, to maintain contact between the mulching head and the ground (sometimes referred to as an “active float” system and method). In embodiments herein, the system and method allow for supporting a vehicle attachment coupled to a vehicle by controlling hydraulic pressure or the like to provide an improved ground-following ability to silvicultural equipment, such as a mulcher (mulching head), attached to a vehicle.

As used herein, the phrase “lift cylinder pressure” generally refers to a pressure applied to a lift cylinder piston to exert a lifting force on an attachment coupled to the lift cylinder. In other words, the lift cylinder piston and the pressure therein controls the elevation of the attachment. The lift cylinder may be positioned with a base-end of the lift cylinder coupled proximal the vehicle and a rod-end of the lift cylinder proximal the attachment, in which case the lift cylinder pressure is the base-end pressure of the lift cylinder. Increasing the lift cylinder pressure increases the lifting force exerted on the attachment. If the lifting force exceeds the down force (typically, the weight) exerted by the attachment, the lift cylinder piston will extend and lift the attachment. Decreasing the lift cylinder pressure will decrease the lifting force and lower the attachment.

The down force exerted by the attachment may be measured by measuring the lift cylinder pressure while the attachment is held off the ground (in the air). The lift cylinder pressure when the attachment is held in the air is sometimes called the free air reading. When the attachment is lowered to make contact with the ground, the ground will exert an upward force on the attachment and the lift cylinder pressure will decrease. The lift cylinder pressure when the attachment is at a position making contact with the ground (touching or on the ground) is sometimes referred to as the ground force. In this situation, the ground may be partly supporting the attachment and the lift cylinder pressure may be partly supporting the attachment to allow movement of the accessory along the ground. A difference between the free air reading and the ground force may be set initially by a user. Because of this relationship, the ground force may be monitored by monitoring the lift cylinder pressure. Further, the lift cylinder pressure may be varied in response to measured changes in the ground force/lift cylinder pressure.

A decrease in lift cylinder pressure below the ground force can indicate that the attachment is making more contact with the ground and the lift cylinder pressure can be increased to raise the attachment. Similarly, a rise in lift cylinder pressure above the ground force can indicate that the attachment is lifting off the ground, and the lift cylinder pressure may be decreased in response to maintain contact between the attachment and the ground. In some embodiments, the decrease in lift cylinder pressure may be controlled to be at a faster rate than a conventional lowering in order to cause the attachment to rapidly return to the ground (or maintain contact with the ground). Using a faster rate of decrease is in contrast to the relatively slow return to the ground typically seen with conventional passive float systems, which are designed to prevent the attachment from being dropped too quickly due to safety or other reasons.

In some embodiments, instead of relying on a general change in lift cylinder pressure, the ground force may be measured by measuring the pressure of hydraulic fluid within the lift cylinder, for example the lift cylinder base. Alternatively, the ground force may be measured by closing a hydraulic valve (or multiple valves) to the base-end and the rod-end of the tilt cylinder. In some cases, the ground force may be exerted on the tilt cylinder, and with the hydraulic valves closed, this force will be exerted as a pressure on the rod-end and base-end of the tilt cylinder. The pressures exerted on the tilt cylinder may generally be measured without interruption, even as the lift force is varied, since the lift force may be varied by varying pressures applied to the lift cylinder and not the tilt cylinder. Cylinder pressures may be measured at multiple locations, including near the engine. Alternatively, the angle or tilt of the attachment may be measured with a rotary encoder, an inclinometer, with a linear displacement transducer on the cylinder, or the like.

In a case where the attachment is a mulcher having a rotating drum, another characteristic may also be used to monitor pressure. During operation, the rotating drum is intended to contact the ground and disrupt the ground and any material located on the ground to mulch the material. Sometimes this ground contact may drive the mulcher into the ground due to changes in terrain elevation or the like, which causes an increased rotational load on the drum, as the drum must disrupt a greater amount of the ground. The drum may be hydraulically driven. The rotational load on the drum may be monitored, and an increase in the rotational load above a threshold may be detected, and in response the attachment may be lifted (for example by increasing the pressure to the lift cylinder base). Lifting the attachment in response to an increase in load may be referred to or considered as an anti-stall feature. Anti-stall features may function in a substantively similar way for non-rotating heads, for example with oscillating heads or the like.

In some embodiments, a method of controlling/supporting a vehicle attachment may include: sensing a ground force; if the ground force is within a first target deadband (i.e a threshold range), a lift cylinder pressure is held at least approximately constant; if the ground force is below a first target deadband, the lift cylinder pressure is decreased; if the ground force is above a target first deadband, the lift cylinder pressure is increased. This arrangement allows the attachment to general stay in contact with the ground but move along the ground evenly. In some embodiments, the method may include sensing an attachment pressure. If the attachment pressure is lower than a second target deadband, the lift cylinder pressure is increased. If the attachment pressure is within or below the second target deadband, the lift cylinder pressure is held. It will be understood that in the various embodiments, the use of a deadband may be replaced by one or more threshold values, which trigger the intended operation.

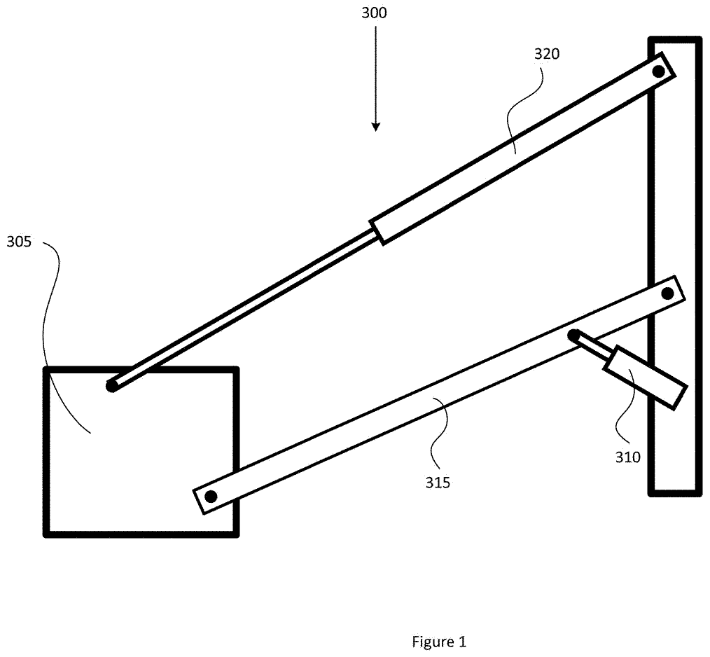

FIG. 1 shows a schematic diagram of an embodiment of a generalized system 300 for controlling/supporting a vehicle attachment with an active float methodology. The system 300 includes an attachment/mulcher head/silvicultural equipment 305, a lift cylinder 310, a boom 315, and a tilt cylinder 320. In some embodiments, the system 800 may not need the tilt cylinder, which could just be a support member. In system 300, the attachment 305 is more distant from the vehicle (not shown) and can have an elevated geometry. The system 300 may also include a sensor for sending a pressure of the lift cylinder and a control system or processor for processing a signal received from the sensor and adjusting a pressure of the lift cylinder based on the sensor signal. In some embodiments, the tilt cylinder may also include a pressure sensor.

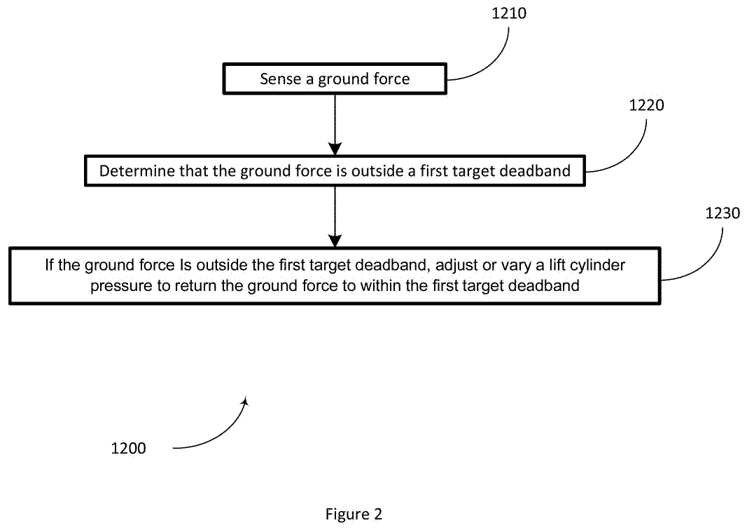

FIG. 2 is a flow chart of a method 1200 for controlling or supporting an attachment, such as the attachment 305.

At 1210, a ground force is sensed. Sensing the ground force may include sensing the ground force continuously or periodically over time. The ground force may be sensed by measuring a cylinder pressure (such as a pressure of the lift cylinder 310) and comparing the cylinder pressure to a free-air reading to calculate the ground force. Sensing a ground force may include measuring a lift cylinder pressure. In some cases, the ground force may be otherwise sensed at a location proximal to the vehicle, for example the ground force may be sensed using a pressure sensor located proximal the vehicle in a valve compartment of the vehicle, where the valve compartment is distal from the attachment. Sensing the ground force at a location proximal the vehicle may enable the use of less expensive sensing equipment, since the sensing equipment does not need to endure the movement and potential damage of sensing equipment located directly on the attachment.

At 1220, it is determined if the ground force outside a first target deadband. The first target deadband may include an upper limit/threshold and a lower limit/threshold. For example, the first target deadband may include a ground pressure target, a deadband negative, and a deadband positive. The deadband negative is the amount below the ground pressure target that is outside the deadband, and the deadband positive is the amount above the ground pressure target that is outside the deadband. The first target deadband may include a target ground force set by the user, for example a ground pressure target. A desired or target ground force may be set by the user of the vehicle by using a slider or other input device on the vehicle. The target ground force may be a range of ground forces with a maximum and minimum ground force.

At 1230, in response to determining that the ground force is outside the first target deadband, the lift cylinder pressure is varied to return the ground force to within the first target deadband. Varying the lift cylinder pressure may include increasing the lift cylinder pressure to return the ground force to within the first target deadband when the ground force is higher than the first target deadband. Varying the lift cylinder pressure may include decreasing the lift cylinder pressure to return the ground force to within the first target deadband when the ground force is lower than the first target deadband.

In some cases, the lift cylinder pressure may be varied within a predetermined response time or response times. The response time of varying the lift cylinder pressure is the time that elapses after sensing the ground force and varying the lift cylinder pressure such that the ground force is returned to the target deadband, which relates to the rate of change of the pressure. A faster response time may avoid moving the attachment into the ground and/or avoid lifting the attachment off the ground too much. A slower response time or a wider deadband range may prevent excessive searching to maintain the ground force within the first target deadband. In particular, varying the cylinder pressure at a higher rate may return the ground force to within the first target deadband more quickly, and thereby prevent the attachment from lifting off or being driven into the ground. Varying a lift cylinder pressure to return the ground force to within the first target deadband may includes varying the lift cylinder pressure to maintain contact between the vehicle attachment and a ground. For example, the deadband may be set with an upper limit on the ground force sufficiently low such that, when the ground force is sensed above the upper limit, the lift cylinder pressure is reduced quickly enough to prevent the attachment from lifting off the ground. Maintaining contact between the vehicle attachment and the ground thereby improves the ground-following capability of the vehicle and the vehicle attachment. Maintaining contact between the vehicle attachment and the ground includes actively floating the vehicle attachment.

The response time may also be related to vehicle speed. For example, in some cases, the vehicle may be operable across terrain at a creep speed and a drive speed, where the drive speed is faster than the creep speed. The response time may include a first response time corresponding to the creep speed and a second response time corresponding to the drive speed, where the second response time is shorter than the first response time. Since elevation changes typically occur more slowly at a slower travelling speed, a slower response time at creep speed may prevent the attachment from lifting off or being driven into the ground while also avoiding excessive searching.

It will be understood that when the ground force is within the first target deadband, the method may hold the lift cylinder pressure constant. Holding the lift cylinder pressure constant while the ground force is determined to be within the first target deadband is intended to support the attachment without requiring movement of the attachment relative to the vehicle, such as would be the case over relatively level ground.

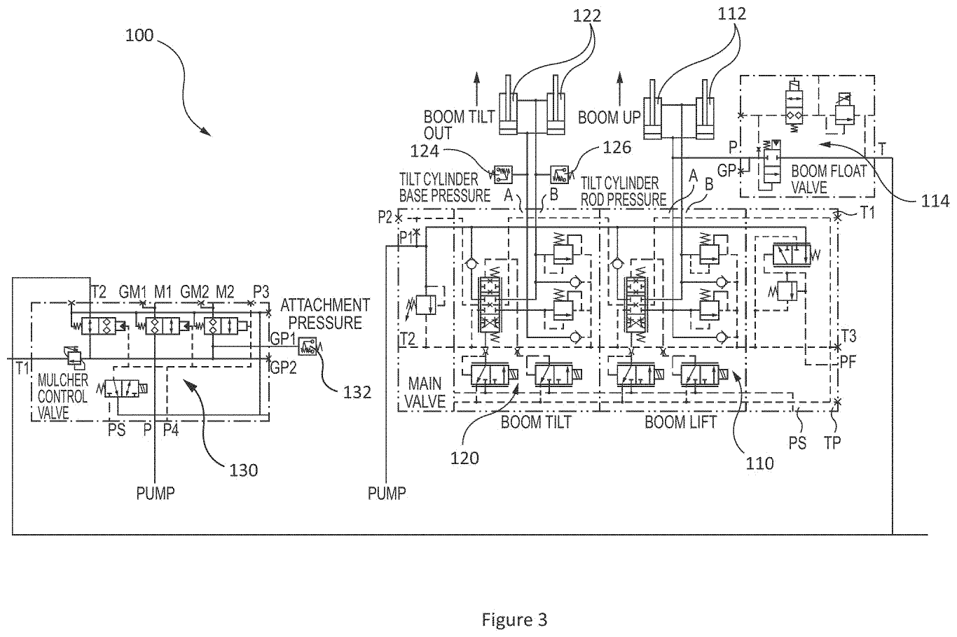

FIG. 3 shows a schematic diagram of an embodiment of a more detailed hydraulic system 100 for controlling/supporting a vehicle attachment with an active float methodology. Hydraulic system 100 includes a lift cylinder valve assembly 110, two lift cylinders 112, a lift cylinder float valve assembly 114, a tilt cylinder valve assembly 120, two tilt cylinders 122, a tilt cylinder base-end pressure sensor 124, a tilt cylinder rod-end pressure sensor 126, an attachment valve assembly 130, and an attachment pressure sensor 132. The lift cylinder valve assembly 110 and the lift cylinder float valve assembly 114 are configured to control the pressure of hydraulic fluid supplied to the two lift cylinders 112. In particular, the lift cylinder valve assembly 110 and the lift cylinder float valve assembly 114 are configured to vary the pressure of hydraulic fluid supplied to the base-end of the two lift cylinders 112. The two lift cylinders 112 may be coupled to a boom, and the boom may be coupled to an attachment. In other words, the two lift cylinders 112 may support the attachment via a boom. It will be understood that the two lift cylinders and/or the two tilt cylinders may alternatively be a single lift cylinder and/or a single tilt cylinder in this or other embodiments.

The tilt cylinder valve assembly 120 is configured to control the pressure of hydraulic fluid supplied to the tilt cylinders 122. The tilt cylinder base-end pressure sensor 124 measures the pressure of hydraulic fluid supplied to the base-end of the tilt cylinders 122, i.e. the tilt cylinder base-end pressure. The tilt cylinder base-end pressure measured by the tilt cylinder base-end pressure sensor 124 may be transmitted to a control system (not shown here). The tilt cylinder rod-end pressure sensor 126 measures the pressure of hydraulic fluid supplied to the rod-end of the tilt cylinders 122, i.e. the tilt cylinder rod-end pressure. The tilt cylinder rod-end pressure measured by the tilt cylinder rod-end pressure sensor 126 may also be transmitted to the control system.

The attachment valve assembly 130 is configured to control the pressure of hydraulic fluid supplied to the attachment (not shown, which may be, for example, a mulches). The attachment pressure sensor 132 is positioned to measure the pressure of hydraulic fluid supplied to the attachment, i.e. the attachment pressure. The attachment pressure measured by the attachment pressure sensor 132 may also be transmitted to the control system.

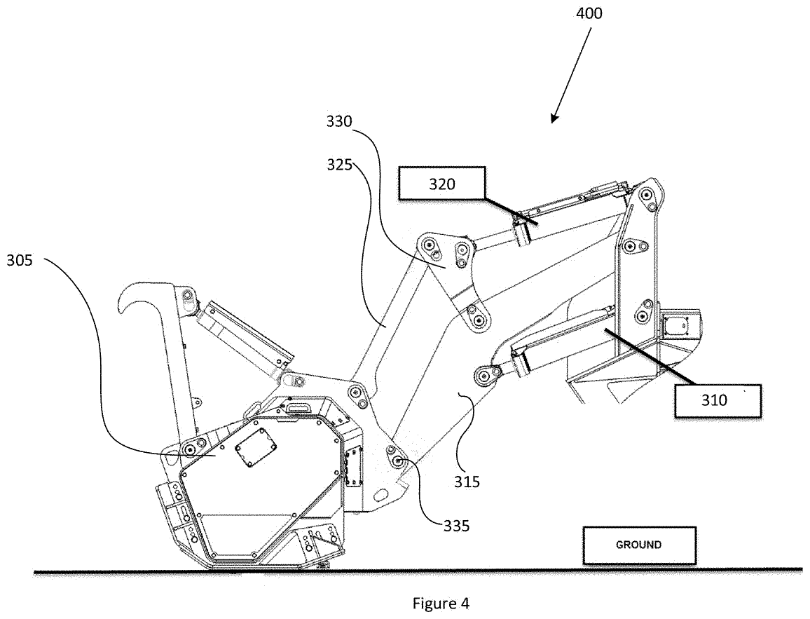

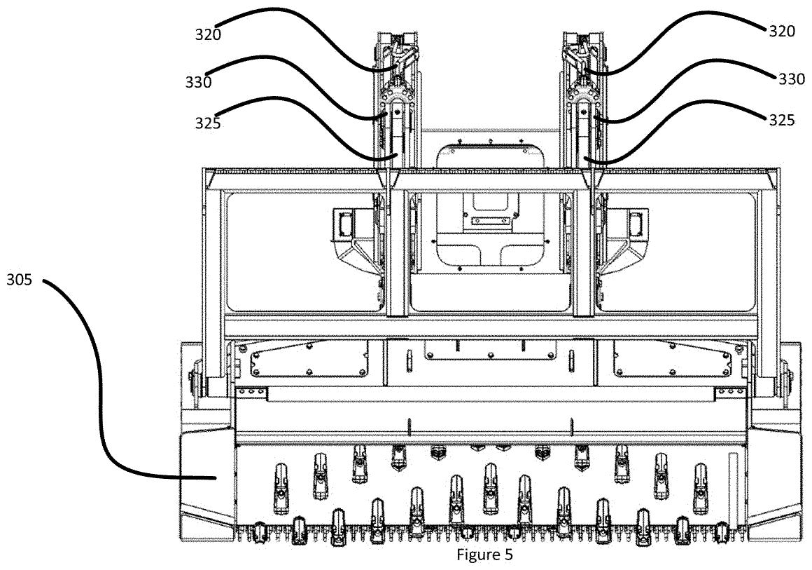

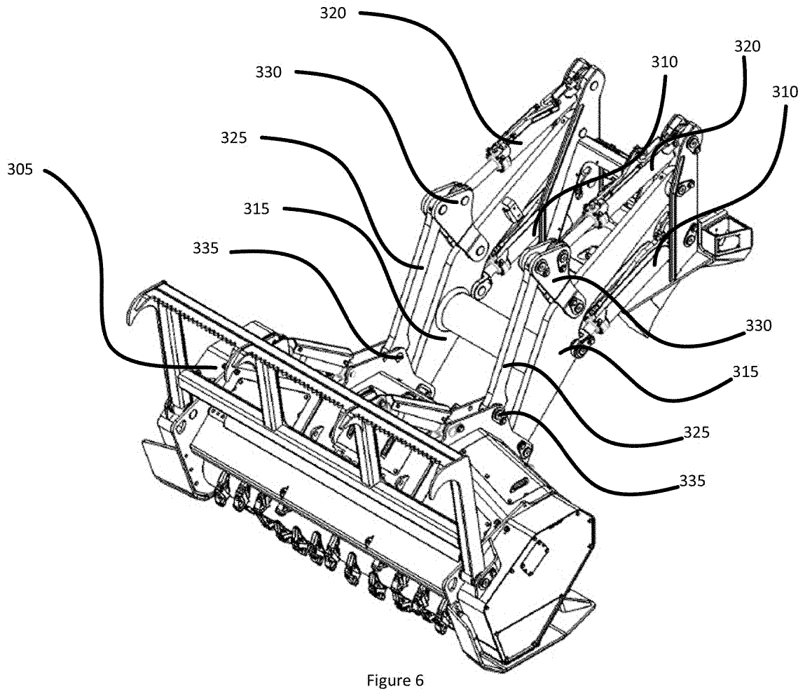

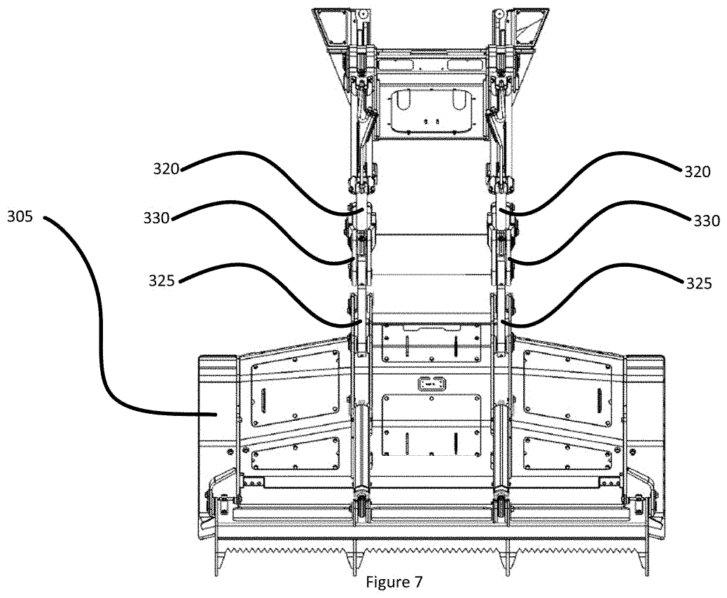

FIGS. 4 illustrates a side view of an embodiment of a system 400 for controlling/supporting a vehicle attachment with an active float methodology. The system 400 includes some similar elements as the system 300 of FIG. 1 and like reference numbers will refer to like elements. The system 400 includes an attachment/mulcher head/silvicultural equipment 305. FIG. 5 shows a front view of the system 400 and the attachment/mulcher head/silvicultural equipment 305. FIG. 6 shows a perspective view of the system 400. FIG. 7 shows a top view of the system 400. Portions of the system/vehicle have been omitted from FIGS. 5, 6, and 7 for clarity.

The system 400 includes attachment 305, lift cylinders 310, booms 315, tilt cylinders 320, first tilt rods 325, second tilt rods 330, and boom pins 335. While system 400 contains two of various elements listed above, two elements may not be necessary and the elements of system 400 are generally discussed below in singular terms. The attachment 305 is pivotably coupled to a first end of the boom 315 via boom pin 335. The attachment 305 is also pivotably coupled to the first tilt rod 325. The first tilt rod 325 is also pivotably coupled to the second tilt rod 330. The second tilt rod 330 is also pivotably coupled to the boom 315 and to a rod end of the tilt cylinder 320. A rod end of the lift cylinder 310 is pivotably coupled to boom 315. A base end of lift cylinder 310, a base end of tilt cylinder 320, and a second end of boom 315 are coupled to a rigid component of vehicle (not shown). Extension of lift cylinder 310 is intended to cause the attachment 305 to lift off the ground, while extension and retraction of tilt cylinder 320 is intended to cause a change in the angle of attachment 305.

In the system 400, the attachment 305 can have an elevated geometry. The lift cylinder 310 may be a boom lift cylinder. The head tilt cylinder 320 may be coupled to tilt rods 325 and 330, however in alternative embodiments the tilt rods 325 and 330 may be omitted as depicted in FIG. 1.

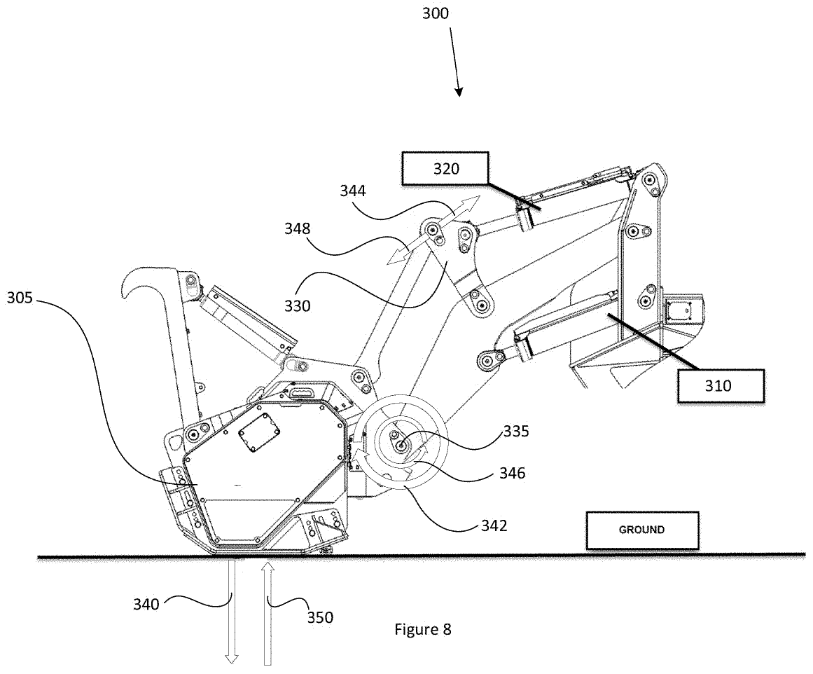

FIG. 8 illustrates the system 400 and at least some of the forces potentially acting, including forces acting upon attachment 305. When attachment 305 is in contact with the ground, the weight of attachment 305 exerts a down force 340 on the ground, and the ground exerts a ground force 350 to support at least some of the weight of attachment 305.

If a change in terrain during movement of system 400 causes the attachment 305 to be driven into the ground, ground force 350 will increase. Due to the support from lift cylinder 310, the increase in upward force 350 creates a first rotational moment 342 around boom pin 335. First rotational moment 342 thereby creates force 344 on second tilt cylinder 330, which is transmitted to tilt cylinder 320 as a pushing force which may be measured as an increase in the base-end pressure of tilt cylinder 320. In other words, an increase in the ground force 350 may be measured by measuring an increase the tilt cylinder base-end pressure.

If a change in terrain during movement of system 400 causes the attachment 305 to begin to lift off the ground, ground force 350 will decrease because a portion of the weight of the attachment 305 is not supported by the ground. Due to the support from lift cylinder 310, the unsupported weight of attachment 305 creates a second rotational moment 346 around boom pin 335. Second rotational moment 346 thereby creates force 348 on second tilt cylinder 330, which is transmitted to tilt cylinder 320 as a pulling force which may be measured as an increase in the rod-end pressure of tilt cylinder 320. In other words, a decrease in the ground force 350 may be measured by measuring an increase the tilt cylinder rod-end pressure.

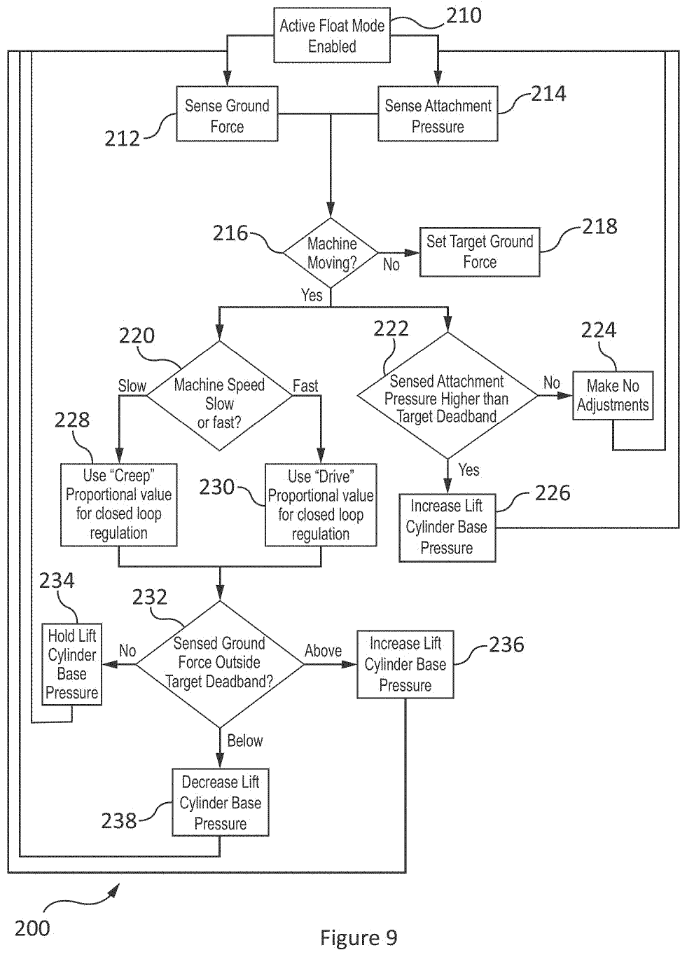

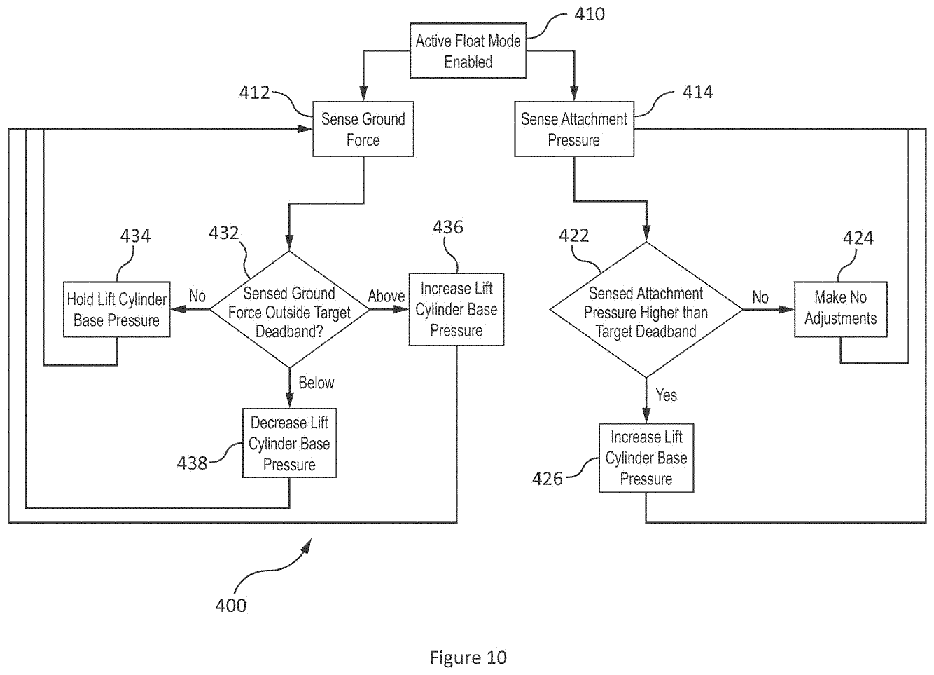

FIGS. 9 and 10 illustrate flow charts of alternative embodiments of a method for controlling/supporting silvicultural equipment herein.

FIG. 9 is a flow chart of an embodiment of a method 200 for controlling or supporting a vehicle attachment coupled to a vehicle. Method 200 is similar in some ways to method 1200 of FIG. 2, however in method 200 a ground force and an attachment pressure can be measured simultaneously. Method 200 may employ Adjust Group Items as discussed herein.

At 210, the Active Float Mode is enabled and method 200 proceeds to 212 and 214 simultaneously. At 212, the ground force is sensed. At 214, the attachment pressure is sensed. At 216, whether the machine is moving or not is determined. If No, Method 200 proceeds to 218. If Yes, the method proceeds to 220 and 222. At 218 the target ground force is set. At 222, whether the sensed attachment pressure is higher than a second target deadband is determined. If No, at 224 no adjustments are made and the method returns to 214. If Yes, at 226 the lift cylinder base pressure is increased and the method returns to 214.

At 220, whether the machine speed is fast or slow is determined. If slow, at 228 the “Creep” proportional value is used for closed loop regulation and method 200 proceeds to 232. If fast, the “drive” proportional value is used for closed loop regulation and method 200 proceeds to 232.

At 232, whether the sensed ground force is outside a first target deadband is determined. If the sensed ground force is not outside the first target deadband, at 234 the lift cylinder pressure is held constant and the method returns to 212. If the sensed ground force is above the first target deadband, at 236 the lift cylinder pressure is increased and the method returns to 212. If the sensed ground force is below the first target deadband, at 238 the lift cylinder pressure is decreased and the method returns to 212.

In method 200, the sensing of the ground force and the sensing of the attachment pressure are performed prior to a check for whether the machine is moving or not. The variation (or lack thereof) of the lift cylinder pressure in response to the sensed ground force is performed after determining whether the vehicle is moving quickly or slowly, which affects the proportional values used for varying the lift cylinder pressure.

FIG. 10 is a flow chart of another embodiment of a method 400 for controlling/supporting a vehicle attachment coupled to a vehicle. Method 400 is similar in some ways to method 1200 of FIG. 2, however in method 400 a ground force and an attachment pressure can be measured simultaneously. Method 400 may employ Adjust Group Items as discussed herein. Method 400 is similar in some ways to method 200.

At 410, the Active Float Mode is enabled and method 400 proceeds to 412 and 414 simultaneously. At 414, the attachment pressure is sensed and method 400 proceeds to 422. At 422, whether the sensed attachment pressure is higher than a second target deadband is determined. If No, at 424 no adjustments are made and the method returns to 414. If Yes, at 426 the lift cylinder base pressure is increased and the method returns to 414.

At 412, the ground force is sensed and method 400 proceeds to 432. At 432, whether the sensed ground force is outside a first target deadband is determined. If the sensed ground force is not outside the first target deadband, at 434 the lift cylinder pressure is held constant and the method returns to 412. If the sensed ground force is above the first target deadband, at 436 the lift cylinder pressure is increased and the method returns to 412. If the sensed ground force is below the first target deadband, at 438 the lift cylinder pressure is decreased and the method returns to 412.

In method 400, the sensing of the ground force and the sensing of the attachment pressure are performed generally simultaneously as part of separate loops. The variation (or lack thereof) of the lift cylinder pressure in response to the sensed ground force is performed independently of the variation (or lack thereof) of the lift cylinder pressure in response to the sensed attachment pressure.

In these methods, the method may further include sensing an attachment pressure to determine if it is higher than a second target deadband, and increasing the lift cylinder pressure to return the attachment pressure to within the second target deadband. As discussed above, when the attachment is driven into the ground the load on the attachment may be increased, increasing the attachment pressure and slowing down the attachment. If the attachment slows sufficiently, the attachment may stall. The second target deadband may be set with an upper limit low enough to prevent the attachment from stalling. The attachment may be lifted to reduce the amount by which the attachment is being driven into the ground and thereby prevent the attachment from stalling, among other benefits. This may be particularly useful for attachments such as a rotary mulcher or an oscillating mulcher.

In some embodiments of the system and method herein, sensing the ground force may include measuring a tilt cylinder rod-end pressure and measuring a tilt cylinder base-end pressure. In this case, the method may further include closing at least one tilt cylinder rod-end hydraulic valve and closing at least one tilt cylinder base-end valve. Closing hydraulic valves to the tilt cylinder base-end and rod-end may allow forces exerted by or on the attachment to be transmitted to the hydraulic fluid within the base-end or rod-end of the tilt cylinder as pressure. Sensing the ground force by measuring the tilt cylinder base-end and rod-end pressures may allow sensing of the ground force while the lift cylinder pressure is being varied. Sensing the ground force may include comparing the tilt cylinder base-end pressure to a tilt cylinder base-end free air reading and comparing the tilt cylinder rod-end pressure to a tilt cylinder rod-end free air reading.

In embodiments herein, actively floating the attachment may reduce energy consumption by the attachment, reduce wear to the attachment, or increase performance of the attachment. For example, if the attachment is a mulcher and is held generally in contact with the ground, the quality of mulch produced will be improved compared to mulch produced by a mulcher being lifted off the ground or driven into the ground due to terrain. A mulcher being actively floated may avoid being driven into the ground, reducing wear to the mulching teeth compared to a mulcher that is driven into the ground during changes in elevation. The active float system is intended to work in a similar way with attachments that have horizontal rotation as a twisting movement can be sensed and controlled similar to the way that rotating or oscillating motion is detected using sensors.

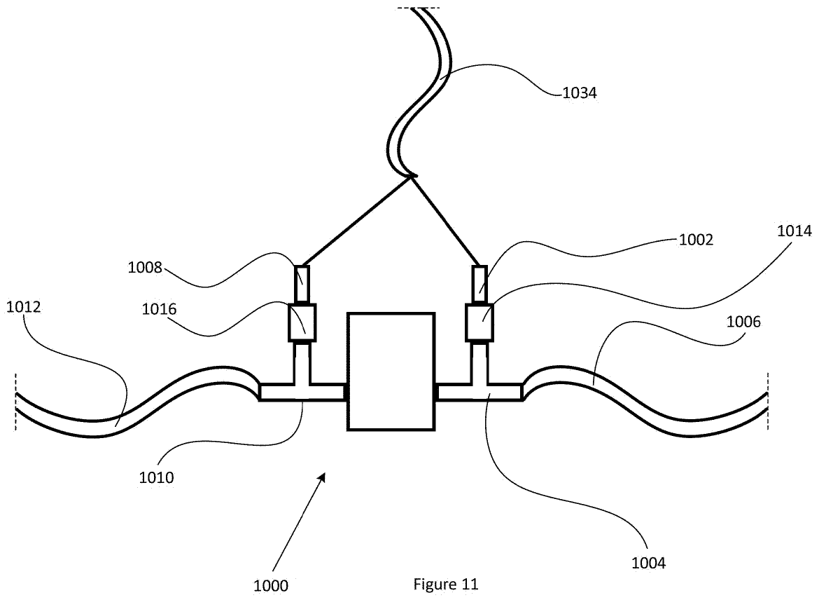

FIG. 11 illustrates an embodiment of a portion of an active float system 1000. FIG. 11 relates to a particular embodiment and illustrates how an existing vehicle/system can be retrofitted to make use of an embodiment of the system and method herein. In this example, a front valve compartment of a vehicle includes a base-end sensor and rod-end sensor. Active float system 1000 includes a first pressure sensor 1002, a first tee fitting 1004, a first hose 1006, a second pressure sensor 1008, a second tee fitting 1010, a second hose 1012, a first adapter 1014, a second adapter 1016, a bus bar 1030, a ground bus bar 1032, a harness 1034, and connector 1036.

In FIG. 11, the first hose 1006 is connected to the first tee fitting 1004 and to the tilt cylinder rod-end. The first tee fitting 1004 is connected to the first adapter 1014 and to the tilt cylinder rod-end valve. The first adapter 1014 is connected to the first pressure sensor 1002. The first pressure sensor is electronically connected to a portion of the harness 1034. The first pressure sensor 1002, first adapter 1014, and first tee fitting 1004 may sometimes be described as a tilt cylinder rod-end sensor. Similarly, the second hose 1012 is connected to the second tee fitting 1010 and to the tilt cylinder base-end. The second tee fitting 1010 is connected to the second adapter 1016 and to the tilt cylinder base-end valve. The second adapter 1016 is connected to the second pressure sensor 1008. The second pressure sensor is electronically connected to a portion of the harness 1034. The second pressure sensor 1008, second adapter 1016, and second Tee fitting 1010 may sometimes be described as a tilt cylinder base-end sensor.

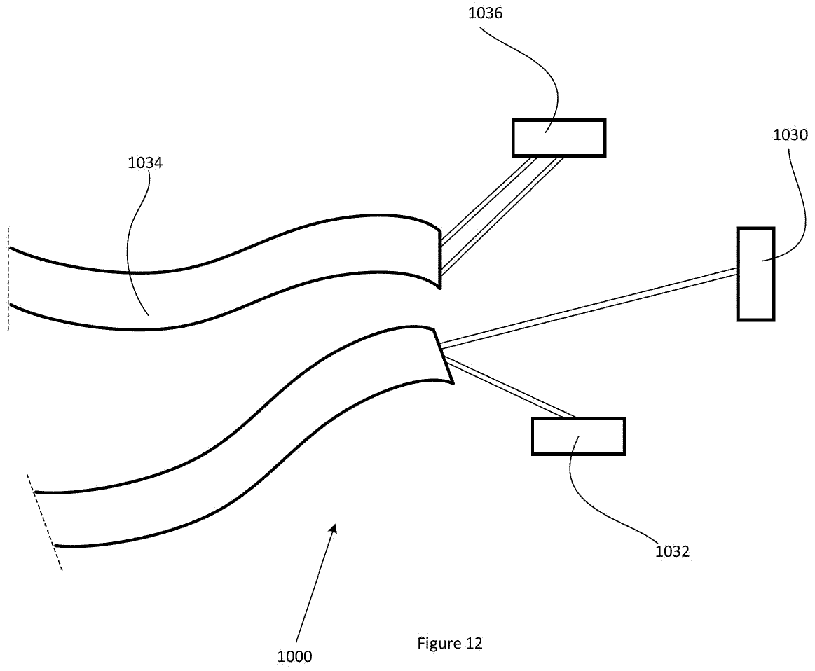

FIG. 12 illustrates an embodiment of another portion of the active float system 1000. This portion of the active float system 1000 includes a bus bar 1030 (for example, a 12 pin bus bar). A skilled person will appreciate that alternative bus bars and/or power supplies may be employed. The bus bar 1030 is electronically coupled to the first pressure sensor 1002 and to the second pressure sensor 1008 to supply electrical power to the first pressure sensor 1002 and to the second pressure sensor 1008. FIG. 12 also shows a ground bus bar 1032 (for example, a 6 pin ground bus bar). Again, a skilled person will appreciate that alternative grounding bus bars and or grounds may be employed. The ground bus bar 1032 is electronically coupled to the first pressure sensor 1002 and to the second pressure sensor 1008 to ground the first pressure sensor 1002 and the second pressure sensor 1008.

FIG. 12 also shows the harness 1034 and portions of harness 1034 are coupled to connector 1036. The connector 1036 is electronically coupled to a control system or processor (not shown) to transmit signals from the first pressure sensor 1002 and from the second pressure sensor 1008 to the control system via harness 1034 and connector 1036. The control system or processor can evaluate/analyze the signals from the pressure sensors and send signals to adjust the pressure in the cylinders accordingly.

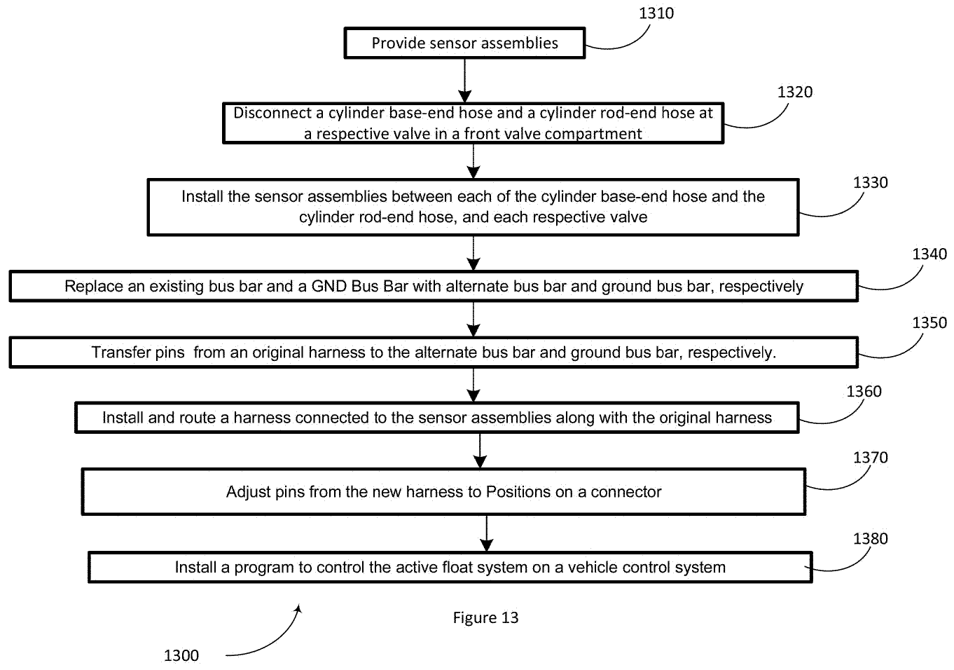

FIG. 13 is a flow chart of an embodiment of a method 1300 for retrofitting an attachment (such as a mulcher) and an associated hydraulic system/vehicle to implement an embodiment of an active float system and method.

At 1310, two sensor assemblies are provided. Each sensor assembly may include a pressure sensor (1002, 1008), an adapter (1014, 1016), and a tee fitting (1004, 1010).

At 1320, a tilt cylinder base-end hose (1012) and a tilt cylinder rod-end hose (1006) are each disconnected at a respective valve in, for example, a front valve compartment.

At 1330, the two sensor assemblies are installed between each of the tilt cylinder base-end hose and the tilt cylinder rod-end hose, and each respective valve.

At 1340, a power bus bar and a GND bus bar are replaced with an alternate bus bar (1030) with additional connectors and an alternate ground bus bar (1032), respectively.

At 1350, power pins and GND pins from an original harness are transferred to the alternate bus bar and the alternate ground bus bar, respectively.

At 1360, a new harness (1034) connected to the two sensor assemblies is installed and routed, in this case, along with the original harness.

At 1370, pins from the new harness can be pinned to a connector, for example, a “TR” pin and a “TB” pin from the new harness can be pinned to positions 24, 39 on a connector, respectively. The method may include un-pinning an IQAN pin from position 39 on the connector.

At 1380, a program to control the active float system is installed on a vehicle control system or on a separate control system. The program can be configured to allow switching between active float mode and standard mode or the like. For example, active float mode may be disabled by default, and a service mode or the like may be activated to access the feature to turn active float mode on.

In some cases, the system and method may include other sensors or the like to provide additional data and various modes of operation. For example, other Adjust Group Items may include: Rotor Active Float Mode, Tilt Active Float Mode, Rotor Proportional, Creep Cut-off, Tilt Drive Proportional, Tilt Creep Proportional, Target Attachment Pressure, Tilt Active Float Dead-band Positive, Tilt Active Float Dead-band Negative, Rotor Active Float Dead-band Positive, Rotor Active Float Dead-band Negative, Min Limit Downforce, Max Limit Downforce, Rotor Derivative, Tilt Integral, Tilt Derivative, and Boom Float Flow FP. Adjust Group Items may be employed to configure the program, and thereby configure the control system to support a vehicle attachment coupled to the vehicle.

As some examples, Rotor Active Float Mode may be set to On or Off, and enables or disables the rotor anti-stall component of the active float. Tilt Active Float Mode may be set to On or Off, and enables or disables the primary active float regulation. Rotor Proportional may be set to, for example, a range of 0-5, and act as a feedback control signal to adjust the head for preventing a stall condition of the drum, where values 1 and higher may react faster to deviations from targeted attachment pressure. Rotor Proportional may be adjusted to increase or decrease response for drum anti-stall. Creep Cut-off may be set to a speed in mph at which the vehicle will transition the active float regulation from a less sensitive response (“Tilt Creep Proportional” Setting) to a more sensitive response (“Tilt Drive Proportional” Setting). Tilt Drive Proportional may be set to, for example, a range of 0-5, and may be a feedback control signal to adjust the head for following the ground when travelling at speeds faster than “creep” (and may be based on a preset value). In particular, values of 1 and higher may react faster to deviations from targeted ground pressure but may have some instability when the machine is moving slow. Tilt Drive Proportional may be adjusted to adjust response at driving speeds. Tilt Creep Proportional may be set to, for example, a range of 0-5, and may be a feedback control signal to adjust the head for following the ground when travelling at creeping speeds. In some cases, values of 1 and higher may react faster to deviations from targeted ground pressure but may have some instability when the system/vehicle is moving slowly. A value of 0.5 for Tilt Creep Proportional may be a preferred value. Tilt Creep Proportional may be adjusted to adjust the response at creeping speeds.

Target Attachment Pressure may be set to, for example, a range of approximately 0-5000 lbs, 0-2000 lbs, or the like depending on the weight of the attachment or the like. Target Attachment Pressure may be a target for attachment pressure regulation, where lower values will have the active float system pull the head away from the ground earlier as the attachment pressure increases with ground engagement. Tilt Active Float Dead-band Positive may be set to, for example, a range of approximately 0-1000 lbs depending on the weight of the attachment, and may be set as the positive dead-band beyond the system's ground pressure target. A greater Tilt Active Float Dead-band Positive may reduce instability and excessive hunting. Tilt Active Float Dead-band Negative may be set to, for example, a range of approximately 0-1000 lbs depending on the weight of the attachment, and may be the negative dead-band beyond the system's ground pressure target. A greater Tilt Active Float Dead-band Negative may reduce instability and excessive hunting. Rotor Active Float Dead-band Positive may be set to, for example, a range of approximately 0-1000 lbs depending on the weight of the attachment, and may be the positive dead-band beyond the system's attachment pressure target. A greater Rotor Active Float Dead-band Positive may reduce instability and excessive hunting. Rotor Active Float Dead-band Negative may be set to, for example, a range of approximately 0-1000 lbs depending on the weight of the attachment, and may be the negative dead-band beyond the system's attachment pressure target. A greater Rotor Active Float Dead-band Negative may reduce instability and excessive hunting.

Min Limit Downforce may be set to, for example, a range of approximately 5000-0 lbs depending on the weight of the attachment, and may control the minimum allowable downforce on the ground. Max Limit Downforce may be set to, for example, a range of approximately 5000-0 lbs depending on the weight of the attachment, and may control the maximum allowable downforce on the ground. Rotor Integral may be set to, for example, a range of 0-unlimited, and, when increased, may improve the closed loop system if the Proportional term is insufficient. Rotor Derivative may be set to, for example, a range of 0-unlimited which, when increased, may improve the closed loop system if the Proportional term is insufficient. Tilt Integral may be set to, for example, a range of 0-unlimited which, when increased, may improve the closed loop system if the Proportional term is insufficient. Tilt Derivative may be set to, for example, a range of 0-unlimited which, when increased, may improve the closed loop system if the Proportional term is insufficient. Boom Float Flow FP may be set to, for example, a range of 0-100%, which may control how much flow the float valve has to work with. A Boom Float Flow FP of 20% may be a preferred value.

Embodiments of the system and method herein may include sensors to provide for a variety of the Adjust Group Items and various embodiments may be created making use of one or more of the various types of sensors and adjustments that are considered herein.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

For the sake of brevity, certain ranges may be explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Embodiments of the disclosure or elements thereof, such as, for example, the controller, control system, processor, or the like may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the embodiments can also be stored on the machine-readable medium. The instructions stored on the machine-readable medium can be executed by a processor or other suitable processing device, and can interface with circuitry to perform the described tasks.

The particular embodiments disclosed above are illustrative only, as the present disclosure may be modified and practiced in different but equivalent manners apparent to those skilled in the art having the benefit of the teachings herein. Although individual embodiments are discussed, the disclosure covers various combinations of those embodiments and an element from one embodiment may be used in another embodiment. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the claims. If there is any conflict in the usages of a word or term in this specification and one or more patent(s) or other documents that may be incorporated herein by reference, the definitions that are consistent with this specification should be adopted.

Many variations of the embodiments set out herein will suggest themselves to those skilled in the art in light of the present disclosure. Such variations are intended to be within the scope of the appended claims.

1. A method for controlling an attachment provided to a boom of a vehicle, the method comprising:
sensing a ground force on the attachment;
determining if the ground force is outside a first target deadband, wherein the first target deadband is configured based on a desired height of the attachment in relation to the ground, and,
if the ground force is outside the first target deadband, adjusting a lift cylinder pressure to return the ground force to within the first target deadband,
otherwise do not adjust the lift cylinder pressure.

2. The method of claim 1, wherein the adjusting the lift cylinder pressure comprises varying the lift cylinder pressure over a predetermined response time or at a predetermined rate.

3. The method of claim 2, wherein the vehicle is operable at a creep speed and a drive speed, the drive speed faster than the creep speed, the response time comprises a first response time corresponding to the creep speed and a second response time corresponding to the drive speed, and wherein the second response time is shorter than the first response time.

4. The method of claim 1, wherein adjusting the lift cylinder pressure to return the ground force to within the first target deadband comprises varying the lift cylinder pressure to maintain contact between the attachment and the ground.

5. The method of claim 1 wherein sensing a ground force comprises sensing a base-end pressure of the lift cylinder.

6. The method of claim 5, wherein sensing the ground force comprises comparing the lift cylinder base-end pressure to a lift cylinder base-end free air reading.

7. The method of claim 1 wherein sensing a ground force comprises sensing a base-end pressure of a tilt cylinder.

8. The method of claim 7, wherein sensing the ground force comprises comparing the tilt cylinder base-end pressure to a tilt cylinder base-end free air reading.

9. The method of claim 1, further comprising:
sensing an attachment pressure related to operation of the attachment;
determining if the attachment pressure is higher than a second target deadband; and
if so, adjusting the lift cylinder pressure to return the attachment pressure to within the second target deadband.

10. The method of claim 1, wherein the attachment is a mulcher.

11. A system for controlling an attachment provided to a boom of a vehicle, the system comprising:
a control system;
a hydraulic system in fluid communication with at least a first piston provided to the boom; and
a first pressure sensor configured to sense a pressure related to the attachment, the first pressure sensor also configured to communicate the sensed pressure to the control system;
wherein the control system is configured to determine if the pressure is outside a first target deadband, and, if so, adjust a pressure at the piston to return the sensed pressure to within the first target deadband, otherwise do not adjust the pressure at the piston.

12. The system of claim 11, wherein the first piston is a lift cylinder for lifting the boom and the first pressure sensor senses a pressure at a base end of the lift cylinder.

13. The system of claim 12, wherein the first pressure sensor senses the pressure by comparing the lift cylinder base-end pressure to a lift cylinder base-end free air reading.

14. The system of claim 11, wherein the first piston is a tilt cylinder configured to adjust an angle of the attachment and the first pressure sensor senses a pressure at a base end of the tilt cylinder.

15. The system of claim 14, wherein the first pressure sensor senses the pressure by comparing the tilt cylinder base-end pressure to a tilt cylinder base-end free air reading.

16. The system of claim 11, wherein the adjusting a pressure at the piston comprises varying the pressure at the piston over a predetermined response time or at a predetermined rate.

17. The system of claim 16, wherein the vehicle is operable at a creep speed and a drive speed, the drive speed faster than the creep speed, the response time comprises a first response time corresponding to the creep speed and a second response time corresponding to the drive speed, and wherein the second response time is shorter than the first response time.

18. The system of claim 11, further comprising:
an attachment hydraulic system in fluid communication with the attachment; and
an attachment pressure sensor configured to sense an attachment pressure related to operation of the attachment and communicate the attachment pressure to the control system;
wherein the control system is further configured to determine that the attachment pressure is higher than a second target deadband, and in response to determining that the attachment pressure is higher than a second target deadband: increase the pressure at the piston to return the attachment pressure to within the second target deadband.

19. The system of claim 11, wherein the attachment is a mulcher.
